(19) United States
(12) Patent Application Publication
(10) Pub. No.: US 2011/0202146 A1
(43) Pub. Date: Aug. 18, 2011

(54) METHOD FOR TRIGGERING ACTIONS OF A MACHINE USING SECURE INPUT ELEMENTS

(76) Inventors: Karsten Heil, Erlangen (DE); Günter Schwesig, Erlangen (DE); Guido Seeger, Baiersdorf (DE)

(21) Appl. No.: 12/673,309

(22) PCT Filed: Aug. 7, 2008
(86) PCT No.: PCT/EP08/60395

§ 371 Date: Feb. 12, 2010

(30) Foreign Application Priority Data
Aug. 16, 2007 (DE) 10 2007 038 722.0

(51) Int. Cl. G05B 11/01

(52) U.S. Cl. 700/12

(57) ABSTRACT

A controller (2) dynamically decides based on the current operating state (Z) thereof whether and optionally which actions it associates with secure input elements (4) of a user interface (3). When a user (9) actuates one of the secure input elements (4), the controller (2) brings about the actuation of the machine (1) in accordance with the action currently associated with the actuated secure input element (4).

The present invention relates to a method for triggering actions of a machine, in which case, when a secure input element is operated by an operator, a control device drives the machine according to the action assigned to the secure input element which has been operated.

The present invention also relates to a control unit for triggering actions of a machine, the control unit being connected at least to a user interface having secure input elements, the control unit being designed in such a manner that it carries out such a method during operation.

Finally, the present invention relates to a computer program containing machine code which can be directly executed by such a control unit. Execution of the machine code by the control unit in this case causes the control unit, when one of the secure input elements is operated by an operator, to drive the machine according to the action assigned to the secure input element which has been operated.

Such methods, control units and computer programs are known.

In industry, control and regulation systems, for example for production machines and machine tools, are used for automation and drive technology. Corresponding devices, for example control panels, machine control panels, keypads and handheld controllers, are used to control, monitor and activate these machines.

Other configurations of user interfaces are also conceivable.

The control and drive systems are optionally available with integrated safety technology (safety-integrated) for so-called “safe movement control”. In the case of safe movement control, particular machine components can be moved for set-up despite reduced safety measures, albeit only at a reduced speed. For example, a milling machine can be moved in this manner in the direction of its x, y and/or z axis for set-up when the guard door is open. In the prior art, the movement command is specified using a secure input element, for example using a so-called secure key. Operation of the key is transmitted to the (likewise fail-safe) control unit, which then triggers the desired action.

In the prior art, the secure keys are arranged, for example, on a machine control panel. In this case, a particular action, for example the movement of a very specific axis, is permanently assigned to each key.

Typical user interfaces, for example the machine control panel mentioned, also have a viewing area which can be used to display messages to the operator. In many cases, soft keys are located below and/or beside the viewing area. In the prior art, the soft keys are normal pushbuttons with a single electrical contact. They are not fail-safe.

In many cases, the available space on the user interface for arranging the input elements is restricted. There is therefore the obligation to provide small input elements in the prior art, as one option. In this case, there is the risk of slipping off or of a key beside the actually desired key being inadvertently operated. Alternatively, only a restricted functionality can be implemented.

If the soft keys are present, the user interface generally also has a so-called menu key. The menu key can be used to select different masks and display them on the visual display unit. Different functions are assigned to the soft keys depending on the mask. In particular, the soft keys can also be used to start actions. However, on account of the fact that the soft keys are only normal pushbuttons with a single electrical contact, triggering of safety-relevant actions is not allowed.

EP 0 742 500 A1 discloses a method for triggering actions of a machine, in which, when a secure input element is operated by an operator, a control unit drives the machine according to the action assigned to the secure input element which has been operated.

DE 34 42 063 C2 discloses a method for triggering actions of a machine, in which case a control unit uses its current operating state to dynamically decide whether and, if appropriate, which actions it should respectively assign to input elements of a user interface, and, when one of the input elements is operated by an operator, drives the machine according to the action currently assigned to the input element which has been operated.

DE 198 26 875 A1 discloses a method for triggering actions of a machine, in which case, in order to check a transmission channel, the control device transmits transmission data to a handheld device, the handheld device transmits the transmitted data back to the controller, and the controller checks the data which have been transmitted back and the data transmitted by it in order to determine whether they are identical.

DE 103 20 522 A1 discloses a method for controlling a safety-critical process, in which, in order to protect against transmission errors, the signals transmitted from input elements to a control unit are coded using a variable keyword.

The object of the present invention is to provide possibilities for also triggering safety-relevant actions which can be flexibly extended if required.

The object is achieved by means of a method having the features of claim 1, a control unit having the features of claim 12 and a computer program having the features of claim 13. The object is also achieved by means of a data storage medium which stores such a computer program. Dependent claims 2 to 11 relate to advantageous refinements of the present invention.

According to the invention, the control unit uses its current operating state to dynamically decide whether and, if appropriate, which actions it should respectively assign to the secure input elements of the user interface. When one of the secure input elements is operated by the operator, the control unit drives the machine according to the action currently assigned to the secure input element which has been operated. In the present invention, the permanent assignment of predetermined actions to the individual secure input elements is thus abandoned. The assignment is now only dynamic. This refinement makes it possible, in principle, to trigger any desired number of actions using fewer secure input elements.

The operator preferably uses a selection device of the user interface to specify a selection of a current operating state for the control unit. The selection is directly or indirectly transmitted from the user interface to the control unit. As a result, the control unit can easily discern the desired assignment of the actions to the secure input elements. In this case, the operating state of the control unit corresponds to the selection of a particular display menu, for example.

A drive unit preferably transmits information to a display device of the user interface, said information revealing whether and, if appropriate, which action is currently respectively assigned to the secure input elements. In this case, the display device displays a message, which corresponds to the transmitted information, to the operator. In this manner, the operator can also easily discern the assignment of the actions to the secure input elements.

It is possible for the selection to be transmitted from the user interface to the drive unit and for the drive unit to transmit the selection to the control unit. Alternatively, the selection can be transmitted from the user interface to the control unit. In this case, the control unit specifies, for the drive unit, which information should be transmitted by the latter to the display device.

A monitoring device preferably checks whether and, if appropriate, which information is transmitted by the drive unit to the display device. In this case, the monitoring device transmits a corresponding message to the control unit. In this case, when one of the secure input elements is operated, the control unit correspondingly drives the machine only when the message transmitted to the control unit and the current operating state of the control unit correspond to one another. This makes it possible to ensure that the message displayed to the operator via the display device and the actual assignment of the actions to the secure input elements correspond to one another or an action which is possibly dangerous on account of the incorrect assignment does not occur.

When the drive unit and the monitoring device are operating properly, the message preferably contains at least one dynamic message part. In this case, the control device may be configured in such a manner that, when one of the secure input elements is operated, it correspondingly drives the machine only when the message contains at least one dynamic message part. This refinement makes it possible to detect if the monitoring device and possibly also the drive unit are defective.

A defect in the drive unit can be detected in a particularly simple manner if the monitoring device determines the at least one dynamic message part using the transmitted information.

The message displayed to the operator preferably contains at least one dynamic message part. This makes it possible for the operator to detect whether the drive unit is malfunctioning.

The message displayed to the operator preferably has a corresponding message element for each secure input element, which message element reveals whether and, if appropriate, which action is currently assigned to the respective secure input element. In this case, an arrangement of the message elements in a display area of the display device preferably corresponds to an arrangement of the secure input elements on the user interface. This measure makes it possible for the operator to intuitively discern the assignment of the actions to the secure input elements in a particularly simple manner. The discernibility is optimal here if the secure input elements are arranged at the edge of the display area and the message elements are displayed in the immediate vicinity of the respective secure input element.

The current operating state of the control unit is preferably coded separately from the assignment of the actions to the secure input elements in the transmitted information.

As a result, the current operating state can be extracted in a simple manner and can be displayed to the operator.

Project planning is preferably used to specify, for the control unit, in which operating state the latter should respectively assign which actions to which secure input elements. This procedure makes it possible to manage the assignment of the actions to the secure input elements and to the operating states in a particularly flexible manner.

Further advantages and details emerge from the following description of an exemplary embodiment in conjunction with the drawings, in which, in a basic illustration:

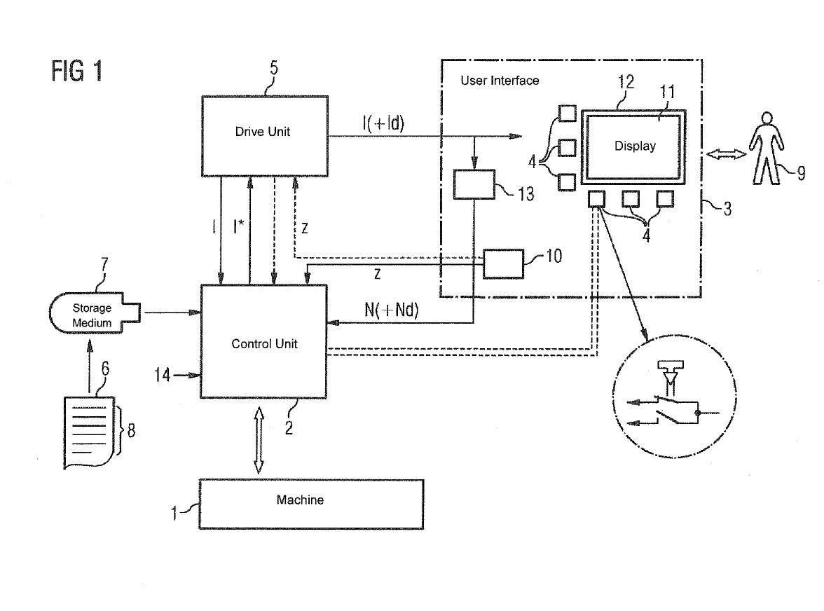

FIG. 1 shows a block diagram of an arrangement for triggering actions of a machine, and

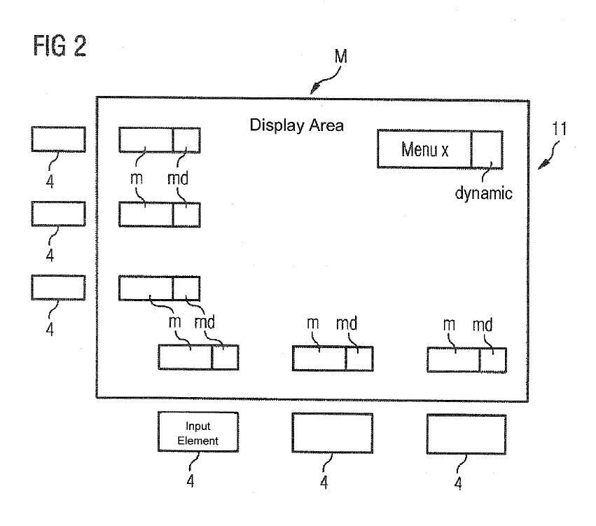

FIG. 2 shows a display area of a display device of a user interface and the environment of said display area.

According to FIG. 1, an arrangement for triggering actions of a machine 1 has a secure control unit 2 and a user interface 3. The user interface 3 has a number of secure input elements 4, for example secure pushbuttons. In this case, the number is at least one. However, a plurality of secure input elements 4 are generally present. The control unit 2 is connected to the user interface 3. In particular, the secure input elements 4 are securely connected to the control unit 2.

Within the scope of the present invention, the term “secure” means fault protection (fail safe) in the sense of a fault-tolerant design of the control unit 2, the input elements 4 and the connections between the input elements 4 and the control unit 2, for example an at least two-channel design. The term “fail-safe” is generally known and familiar to experts. It is usually defined in national and international standards. The corresponding elements (input elements 4, control units 2, types of connection etc.) are generally known as such to experts.

The arrangement generally has further components, in particular a drive unit 5. The drive unit 5 may be an integral part of the control unit 2. Alternatively, it may be connected to the control unit 2. The drive unit 5 is connected to the user interface 3. The drive unit 5 may or may not be fail-safe. The connection between the drive unit 5 and the control unit 2 and the user interface 3 may or may not be fail-safe as well.

Furthermore, for the sake of completeness, it should be mentioned that the user interface 3 may contain further, non-secure input elements in addition to the secure input elements 4. However, within the scope of the present invention, only the secure input elements 4 are important.

The control unit 2 is generally in the form of a software-programmable control unit. Its method of operation is therefore determined by a computer program 6 which is used to program the control unit 2. The control unit 2 may be programmed, for example, by storing the computer program 6 in machine-readable form on a suitable data storage medium 7 (for example a USB memory stick, a memory card, a pluggable EEPROM etc.) and supplying it to the control unit 2 via the data storage medium 7.

The computer program 6 contains machine code 8 which can be directly executed by the control unit 2. Execution of the machine code 8 by the control unit 2 causes the control unit 2 to carry out a method for triggering actions of the machine 1, which method will be described in detail below.

The control unit 2 can be used to control safety-relevant actions and non-safety-relevant actions of the machine 1.

One example of a non-safety-relevant action is a tool change during normal operation of the machine 1. Further examples of non-safety-relevant actions are the specification of a desired speed during normal operation or a normal stop command. One example of a safety-relevant action is the movement of a machine element of the machine 1 in the case of limited safety, for example when the guard door is open. Such operation is carried out, for example, during the so-called set-up of the machine 1. Only a reduced speed is permissible when setting up the machine 1. Furthermore, it must be ensured that the respective machine element is moved only when a corresponding action has actually been requested by an operator 9.

The control unit 2 may assume different operating states Z. For example, the operator 9 can use a selection device 10 (menu key) of the user interface 3 to specify a selection of an operating state Z for the control unit 2. In this case, the specification can be transmitted to the control unit 2 directly, for example (see the solid line from the selection device 10 to the control unit 2 in FIG. 1). Alternatively, the selection can be transmitted to the drive unit 5 and can be forwarded from the drive unit 5 to the control unit 2 (see the dashed line from the selection device 10 to the drive unit 5 and from there to the control unit 2 in FIG. 1). The selection device 10 may be, for example, a simple (not necessarily secure) key which can be used to specify different operating states Z for the control unit 2 in succession. Other types of selection are also possible, for example specification via a rotary switch or a numerical keypad.

The control unit 2 uses its current operating state Z to dynamically decide whether and, if appropriate, which actions it should respectively assign to which of the secure input elements 4. For example, the control unit 2 can
assign an action of moving a particular machine element in the x direction in a first operating state Z,
assign an action of moving the same machine element in a different direction in a second operating state Z,
assign an action of moving another machine element in a third operating state Z,
assign no action in a fourth operating state Z, and
assign another action, which, in contrast to the first three of the above-mentioned operating states Z, is not relevant to safety, for example the function of the selection device 10, in a fifth operating state
   to the secure input element 4, whose connections to the control unit 2 and to the drive unit 5 are depicted in FIG. 1.

Actions are correspondingly individually also assigned to the other secure input elements 4, whose wiring is not illustrated in FIG. 1 (only for the sake of clarity). In this case, at least one operating state Z of the control unit 2, in which a safety-relevant action is assigned to the respective secure input element 4, preferably exists for each secure input element 4.

When one of the secure input elements 4 is operated by the operator 9, the control unit 2 correspondingly drives the machine 1. It goes without saying that the driving operation is carried out in this case according to the action which is currently assigned to the secure input element 4 which has been operated.

In the simplest case, the control unit 2 directly drives the machine 1. Alternatively, the control unit 2 can forward the request for the action to another control unit, which is not illustrated in FIG. 1 and is preferably fail-safe.

The selection of a new operating state Z first of all generally causes all actions to be banned. The ban is maintained until a message M is displayed to the operator 9 via a display area 11 of a display device 12 of the user interface 3. The message M reveals whether and, if appropriate, which actions are now assigned to the individual secure input elements 4 on account of the new selection of the operating state Z. The ban is then lifted again.

If the selection of the operating state Z is directly transmitted to the control unit 2, the control unit 2 specifies, for the drive unit 5—for example in the form of the specification of desired information I*—, which information I should be transmitted by the drive unit 5 to the display device 12. Alternatively, in order to specify the desired information I*, it goes without saying that a coded specification can be given, for example in the transmission of a number for the respective operating state Z. The drive unit 5 then transmits the corresponding information I to the display device 12.

The information I reveals whether and, if appropriate, which actions are assigned to the individual secure input elements 4. The display device 12 is therefore able to display a message M, which corresponds to the information, to the operator 9 via the display area 11.

If the selection of the operating state Z is transmitted to the drive unit 5, the drive unit 5 itself determines the information I to be transmitted to the display device 12 and transmits said information to the display device 12. It also transmits the selection of the operating state Z to the control unit 2. In this case too, the selection can be transmitted to the control unit 2 by transmitting a code for the operating state Z and/or by transmitting the information I to be displayed, for example.

According to FIG. 2, the message M displayed to the operator 9 preferably has a separate corresponding message element m for each secure input element 4. The respective message element m reveals whether and, if appropriate, which action is currently assigned to the corresponding secure input element 4. The information I transmitted from the drive unit 5 to the display device 12 is preferably constructed in a similar manner.

This procedure is particularly advantageous if—again see FIG. 2—an arrangement of the message elements m in the display area 11 corresponds to an arrangement of the secure input elements 4 on the user interface 3. In this case, this procedure is very particularly advantageous if the secure input elements 4 are arranged at the edge of the display area 11. This is because the assignment of the actions to the secure input elements 4 can be immediately and intuitively discerned in this case. However, other refinements are alternatively possible, for example a list of the actions below or beside one another, the secure input elements 4 being arranged below or beside one another.

The current operating state Z of the control unit 2 is preferably also concomitantly displayed in the display area 11. This can be implemented in a particularly simple manner if the current operating state Z is coded separately from the assignment of the actions to the secure input elements 4 in the transmitted information I. For example, the information I may include a number for the respective operating state Z and the respective message elements m of this state Z.

A monitoring device 13 is preferably provided in order to preclude incorrect operation by the operator 9 if the displayed message M does not correspond to the actual operating state Z on account of a malfunction. The monitoring device 13 checks whether and, if appropriate, which information I is transmitted by the drive unit 5 to the display device 12. It then transmits a corresponding message N to the control unit 2.

When one of the secure input elements 4 is operated, the control unit 2 correspondingly drives the machine 1 only when the message N transmitted to the control unit 2 and the current operating state Z of the control unit 2 also correspond to one another at the same time. Otherwise, an action is not triggered, despite the secure input element 4 being operated. However, a fault message may be displayed if necessary.

When the drive unit 5 and the monitoring device 13 are operating properly, the message N preferably contains at least one dynamic message part Nd. For example, the transmitted information I may already contain a dynamic information part Id which can be extracted from the transmitted information I by the monitoring device 13. In this case, the monitoring device 13 thus determines the dynamic message part Nd using the transmitted information I. In this case, the transmitted information I may contain a separate dynamic information part Id for each individual message element m, for example. Alternatively, the transmitted information I may also contain a common dynamic information part Id, for example in addition to the code for the operating state Z.

According to FIG. 2, the message M displayed to the operator 9 preferably likewise contains at least one dynamic part, which is called the dynamic message segment md below in order to distinguish it from the dynamic message part Nd. The assignment of the dynamic message segment md to the message M may be similar to the assignment of the dynamic information part Id to the transmitted information I. In particular, each individual message element m may contain a separate dynamic message segment md.

If the message N contains the dynamic message part Nd, the control unit 2 can check whether the message N actually contains the dynamic message part Nd.

When one of the secure input elements 4 is operated, said control unit can therefore suppress the corresponding driving of the machine 1 if the message N does not contain the at least one dynamic message part Nd. When one of the secure input elements 4 is operated, the machine 1 is correspondingly driven only if the message N contains the at least one dynamic message part Nd.

It is possible for it to have been determined in advance in which operating state Z which action is assigned to which of the secure input elements 4. The determination process can be carried out, for example, using the computer program 6. However, project planning 14 can preferably be used to specify the corresponding assignment for the control unit 2 independently of the computer program 6.

The procedure according to the invention has many advantages. In particular, the actions—to be precise both non-safety-oriented actions and safety-oriented actions—can be allocated to the individual secure input elements 4 in a flexible manner and as required. In this case, the number of safety-oriented actions is not limited by the number of secure input elements 4.

Different refinements of the present invention are possible. For example, the monitoring device 13 may be dispensed with and listening can be carried out directly by the control unit 2 instead. It is also possible to combine the control unit 2 and the drive unit 5 to form a common unit. The drive unit 5—if appropriate including the control unit 2—may also be arranged in the user interface 3.

The individual message elements m may consist of two different parts, for example. The first part corresponds to an item of language-specific information for the operator 9, and the second part is action-specific. For example, the second part may include information relating to the action to be triggered, the assigned secure input element 4 and/or the respective operating state Z of the control unit 2. If appropriate, it also contains the dynamic message segment md of the respective message element m.

Furthermore, the transmitted information I, I*, messages M and messages N may be provided, in their entirety or in their individual parts, with check information, for example checksums, parity bits, CRCs and the like.

Furthermore, it is likewise possible to supply the drive unit 5 with an item of information relating to which secure input element 4 has been operated. The operation of supplying the information to the drive unit 5 may or may not be fail-safe in this case. In the prior art, the operation of supplying the corresponding information to the drive unit 5 is used, for example, to indicate, via the display device 12, whether or not the respective secure input element 4 is currently operated. For example, the assigned message element m may be inverted or may be displayed in flashing fashion. However, according to the invention, if one of the secure input elements 4 is operated, the drive unit 5 transmits a code to the control unit 2—possibly in addition to the modification to the displayed message M—, said code revealing which action has been requested. A code which is characteristic of the action currently assigned to the respective secure input element 4 is thus transmitted. The control unit 2 is therefore able to also concomitantly check this code and, if necessary, to avoid triggering the corresponding action in the event of a discrepancy. The degree of fault protection is therefore increased even further. The transmitted code can be derived from the corresponding message element m or from the corresponding part of the information I, for example.

Finally, it goes without saying that a corresponding fault message may be displayed if any type of fault is detected. It is also possible to create a fault log.

Within the scope of implementing the present invention, it is not crucial whether or not the actions assigned to the secure input elements 4 are relevant to safety. However, the above-described measures according to the invention serve the purpose of being able to request safety-relevant actions in a simple and convenient manner. Therefore, the present invention develops its full potential only in conjunction with safety-relevant actions.

The above description is used only to explain the present invention. In contrast, the scope of protection of the present invention should be determined solely by the accompanying claims.

It should be noted at this point that the machine may be in the form of a machine tool, a production machine and/or a robot, for example.

1.-14. (canceled)

15. A method for operating a machine, comprising the steps of:
dynamically assigning, with a control unit of the machine and based on a current operating state of the control unit, a secure input element of a user interface of the machine to an action; and
upon actuation of the corresponding secure input element by an operator of the machine, controlling the machine according to the currently assigned action.

16. The method of claim 15, further comprising the steps of:
selecting with a selection device of the user interface a current operating state for the control unit; and
directly or indirectly transmitting the selected operating state from the user interface to the control unit.

17. The method of claim 15, further comprising the steps of:
transmitting with a drive unit information to a display device of the user interface, said information indicating the action currently assigned to the secure input element; and
displaying on the display device to the operator a message that corresponds to the transmitted information.

18. The method of claim 17, further comprising the step of:
transmitting the selected operating state from the user interface to a drive unit and from the drive unit to the control unit; or
transmitting the selected operating state from the user interface to the control unit, and specifying with the control unit the information to be subsequently transmitted by the drive unit to the display device.

19. The method of claim 17, further comprising the steps of:
monitoring with a monitoring device the information being transmitted from the drive unit to the display device;
transmitting with the monitoring device a corresponding message to the control unit; and
controlling, upon actuation of one of the secure input element, the machine with the control unit only when the message transmitted to the control unit correspond to the current operating state of the control unit.

20. The method of claim 19, wherein the message includes at least one dynamic message part indicating that the drive unit and the monitoring device operate properly, and controlling the machine with the control unit only if, upon actuation of one of the secure input elements, the message contains the at least one dynamic message part.

21. The method of claim 20, wherein the monitoring device determines the at least one dynamic message part from the transmitted information.

22. The method of claim 17, wherein the message displayed to the operator comprises at least one dynamic message segment.

23. The method of claim 17, wherein the message displayed to the operator comprises for each secure input element a corresponding message element indicating the action currently assigned to the respective secure input element, and wherein the message elements are arranged in a display area of the display device commensurate with an arrangement of the secure input elements on the user interface.

24. The method of claim 17, wherein the current operating state of the control unit is encoded in the transmitted information separately from the assignment of actions to corresponding secure input elements.

25. The method of claim 15, further comprising the step of specifying, using project planning, to the control unit the action to be assigned to a corresponding secure input elements for a predefined operating state.

26. A control unit for triggering actions of a machine, comprising:
at least one user interface connected to the control unit and having secure input elements, wherein the control unit is configured to operate the machine by
dynamically assigning, based on a current operating state of the control unit, a secure input element of a user interface of the machine to an action; and
upon actuation of the corresponding secure input element by an operator of the machine, controlling the machine according to the currently assigned action.

27. A computer program stored on a computer-readable medium and containing machine-executable program code which can be directly executed by a control unit comprising at least one user interface having secure input elements, wherein execution of the machine-executable program code causes the control unit to operate a machine by
dynamically assigning, based on a current operating state of the control unit, a secure input element of a user interface of the machine to an action; and
upon actuation of the corresponding secure input element by an operator of the machine, controlling the machine according to the currently assigned action.

28. A data storage medium having the machine-readable computer program of claim 27 stored on the data storage medium.
